(19) United States
(12) Patent Application Publication
(10) Pub. No.: US 2013/0254295 A1
(43) Pub. Date: Sep. 26, 2013

(54) SOCIAL NETWORK SERVICE APPARATUS AND SERVICE METHOD THEREOF

(71) Applicant: Kang Min Lee, Seoul (KR)

(72) Inventor: Kang Min Lee, Seoul (KR)

(21) Appl. No.: 13/991,527

(22) PCT Filed: Dec. 8, 2011
(86) PCT No.: PCT/KR2011/009487

§ 371 Date: Jun. 4, 2013

(30) Foreign Application Priority Data
Dec. 9, 2010 (KR) 10-2010-0125644

(51) Int. Cl. H04L 29/08

(52) U.S. Cl. CPC H04L 67/02; H04L 51/32
USPC 709/204; 709/206

(57) ABSTRACT

Disclosed are a social network service apparatus and a service method thereof. The social network service apparatus according to an embodiment of the present invention comprises: a cyber space providing unit which provides each member with a dedicated secret cyber space on a network, wherein the cyber space includes at least one of a web page and a WAP page; a friend information storage unit which stores information on registered friends of each member; a friend designation unit which designates, as a communication target, at least one of the friends stored in the friend information storage unit by each member, or designates at least one of friends as a person having a data sharing authority in correspondence to the data uploaded in the cyber space; and a data sharing information transmitting unit which determines whether the friend designated by the friend designation unit has accessed the network, and, if the designated friend has accessed, pushes sharing information on the data for which the designated friend has a sharing authority from among the data uploaded in the cyber space, to the terminal of said designated friend in a predetermined cycle.

### CROSS-REFERENCE TO RELATED APPLICATION

This application claims the benefit of Korean Patent Application No. 10-2010-0125644, filed on Dec. 9, 2010 in the Korean Intellectual Property Office, the disclosure of which is incorporated herein by reference.

### TECHNICAL FIELD

The present invention relates to a social network service apparatus and a service method thereof, and in particular to a social network service apparatus and a service method thereof which has features in that a friend group is made through a function (open key) of helping make a friend relationship in such a way that a user designates one acquaintance at a time or make a plurality of friend relationships at a time, so a 1 to 1 (individual) friend relationship and an authorization is basically set up between the user and the acquaintances, and a secret is set between the user and each friend so that they can know, in a permitted range, a relationship of them, a communication content between them and a sharing situation of data, and the data that the user uploaded in a push way based on the set friend relationship are shared 1 to 1 between the connected friends, and the information are jointly built between the acquaintances based on the set authorization and the shared data, and the information are re-shared, by means of which a full range of social network service can be achieved.

### BACKGROUND ART

In the modern informative society, a computer and an Internet have become a necessary tool in terms of communications as a medium of transferring various information. In this context, a new relationship among people comes to form about the network.

A SND (Social Network Service) or a SCS (Social Community Service) is referred to a service that forms and maintains a community including specific persons of which each user has a specific relationship based on the Internet environment.

The SNS at the first stage of introduction begun in a form of chatting-based community which was performed based on a PC (Personal Computer) communication, and afterward, the PC environment advanced from the PC communication to the WWW (World Wide Web) environment, which provoked a change in the social network service environment, and with the development in the field of the blog, the social network service has started in full scale.

In recent years, the wired and wireless social network services have been launched, which are a wired and wireless cooperating social network configured to be used on a mobile communication terminal like a cellular phone, a smart phone, etc. and a wired internet in a convenient way. Since mobility is made possible by a mobile communication terminal, a user can advantageously record his own thought and feeling wherever and whenever or can invite others. The key feature of the above service lies in easily inviting as a friend all the acquaintances registered in an address list and a messenger of a mobile communication terminal and in sending a user's text through a text message function and a messenger even to acquaintances who are not registered in a corresponding service, so it is possible to integrally control all personal connections of the users.

In the typical social network service, the data the user uploaded can be viewed only when the friends that the user designated visit the user's blog or homepage, so the friends who don't visit the user's blog or homepage cannot know the data that the users uploaded.

In addition, the typical social network service is operated in such a way that the generator who generates contents and the customer who consumes the contents are separated, so it is hard to create a shared and common value that the social network targets to obtain.

The typical social network service is being provided in an open format like the blog or cafe that the user himself operates, a person that the user does not want can visit or a content and a communication that the user does not want may be generated, so the user may have a problem in its management and operation, which is not intended by the user due to the above mentioned problem, so a personal privacy protection is not guaranteed.

In addition, the typical social network service has another problem in that when the data are transmitted and shared in real time through the mobile communication terminals of the friends registered in the address list and the messenger in cooperation with the mobile communication terminal, the sharing is allowed depending on the text data or the low capacity due to the limits in the data transmission speed and the data storage capacity.

### DISCLOSURE OF INVENTION

Accordingly, the present invention is made to resolve the above mentioned problems, and it is an object of the present invention to provide a social network service apparatus and a service method thereof which has features in that a friend group is made through a function (open key) of helping make a friend relationship in such a way that a user designates one acquaintance at a time or make a plurality of friend relationships at a time, so a 1 to 1 (individual) friend relationship and an authorization is basically set up between the user and the acquaintances, and a secret is set between the user and each friend so that they can know, in a permitted range, a relationship of them, a communication content between them and a sharing situation of data, and the data that the user uploaded in a push way based on the set friend relationship are shared 1 to 1 between the connected friends, and the information are jointly built between the acquaintances based on the set authorization and the shared data, and the information are re-shared, by means of which a full range of social network service can be achieved, and the present invention can overcome the limits in terms of the data sharing in the mobile communication terminal.

To achieve the above objects, according to an embodiment of the present invention, there is provided a social network service apparatus, comprising a cyber space provision unit providing a cyber space in which a secret is exclusively kept on a network including by the subscriber at least one among a Web page and a Wap page; a friend information storage unit storing an information on a friend registered by the subscriber; a friend designation unit which designates as a communication opponent at least one among the friends stored in the friend information storage unit by each subscriber or designates, as a person having a sharing authorization of the data, at least one among the friends stored in the friend information storage unit in response to the data uploaded in the cyber space; and a data sharing information transmission unit which judges a connection state of a friend designated by the friend designation unit and pushes to the terminal of the designated friend a sharing information of the data among the data uploaded in the cyber space, the sharing authorization of the data being assigned to a corresponding friend.

Preferably, the social network service apparatus further comprises a data storage unit for storing the data by relating the subscriber and a friend designated by the friend designation unit to the sharing authorization of the data uploaded with respect to the data uploaded in the cyber space and the authorization information including at least one selected from among a modification, a deletion, an addition and a transfer.

In addition, the social network service apparatus comprises an open key helping form a friend relationship with multiple persons at a time for the purpose of expanding quantity in terms of friend relationship.

In addition, the social network service apparatus further comprises an authorization assignment unit for assigning an authorization with respect to at least one selected from among a read, an addition, a modification, a deletion and a transfer with respect to the friend designated by the friend designation unit.

In addition, the social network service apparatus further comprises a message transmission unit transmitting to the terminal of the designated friend a guide message for the purpose of guiding a connection when it is judged that a designated friend is not connected when the data is uploaded in the cyber space.

Here, the data sharing information transmission unit judges a connection state of the subscriber corresponding to the data uploaded in the cyber space, and searches a data uploaded in the cyber space on the terminal of the subscriber when the subscriber is connected and pushes at a certain cycle the data, the sharing authorization of which is assigned to the subscriber, to the terminal of the subscriber.

In addition, the data storage unit sorts the data uploaded in the cyber space as one of a content, a document, a schedule management, an address information and a material information and stores them.

To achieve the above objects, there is provided a social network service method, comprising providing a cyber space in which a secret is exclusively kept on a network including by the subscriber at least one among a Web page and a Wap page; storing an information on a friend registered by the subscriber; designating as a communication opponent at least one of the friends stored in the friend information storing step by each subscriber by corresponding to the data uploaded in the cyber space by each subscriber or designating as a friend having a sharing authorization of the data at least one person among the friends stored in the friend information storage step by corresponding to the data uploaded in the cyber space; judging a connection state of the friend designated by the friend designation unit; and pushing at a certain cycle the data the sharing authorization of which is assigned to a corresponding friend, among the data uploaded in the cyber space, to the terminal of the designated friend when the designated friend is connected.

Preferably, the social network service method further comprises storing the data by relating the subscriber with respect to the data uploaded in the cyber space and a friend designated to the sharing authorization of the data uploaded by the friend designation unit.

In addition, the social network service method comprises an open key helping form a friend relationship with multiple persons at a time for the purpose of expanding quantity in terms of friend relationship.

In addition, the social network service method further comprises assigning an authorization with respect to at least one among a read, an addition, a modification, a deletion and a transfer with respect to the friend designated by the friend designation step.

In addition, the social network service method further comprises transmitting a guide message, which guides a connection, to the terminal of the designated friend when it is judged that the designated friend is not connected when the data is uploaded in the cyber space.

Here, the data push step judges a connection state of the subscriber corresponding to the data uploaded in the cyber space, and searches a data uploaded in the cyber space on the terminal of the subscriber when the subscriber is connected and pushes at a certain cycle the data, the sharing authorization of which is assigned to the subscriber, to the terminal of the subscriber.

In addition, the data storage step sorts the data uploaded in the cyber space as one of a content, a document, a schedule management, an address information and a material information and stores them.

In addition, in the social network service method, the friend who is assigned (provided) with a sharing authorization with respect to the data uploaded in the cyber space and the authorization information including at least one among a modification, a deletion, an addition and a transfer relays a corresponding data to other friends who have a friend relationship with himself.

In addition, the above mentioned social network service method, two persons having friend relationship with himself in terms of the friend relationship are in an exclusive secret relationship with respect to a personal information so that the two persons cannot now ant information on themselves before they make a friend relationship with each other.

In addition, in the above mentioned social network service method, the data is copied between a transmitter and a receiver with respect to the data uploaded in the cyber space and is not transmitted, and only one data is generated, and a sharing authorization with respect to the data is assigned to the friends who becomes a receiving opponent of the data, and a sharing information is transmitted from the data sharing information transmission unit to the friends who are assigned with a sharing authorization, and the friends having the sharing authorizations can connect to a corresponding data.

In addition, in the above mentioned social network service method, a cyber space provision unit immediately provides a cyber space to the persons who click an open key by receiving an open key and disposing the same in the cyber space which becomes a contact point with the persons who want a friend relationship for thereby making a friend relationship with the user, and the friend information storage unit separately sorts the friends and stores and manage them.

In addition, in the social network service method, in case that a user shares a communication and data with the friends, even when a communication and data are shared by designating multiple friends, each friend is connected with a user based on a 1:1 connection, and it is displayed as a 1:1 relationship so that the friends can feel such connection like a private relationship communication.

In addition, in the social network service method, there is provided a combined multimedia method which can provide an image, a motion image and a file as well as a map information in addition to a real time message and the information provided by the cyber space provision unit and transferred in a simple form of text in a shared schedule which are serviced in a cyber space in which a secret is exclusively kept on the network.

### ADVANTAGEOUS EFFECTS

According to the embodiments of the present invention, the social network service apparatus and a service method thereof have features in that in a cyber space in which a secret is exclusively kept on a network containing at least one among a Web page and a Wap page by the user, a friend group can be made through a function (open key) of helping make a friend relationship in such a way that a user designates one acquaintance at a time or make a plurality of friend relationships at a time, so a 1 to 1 (individual) friend relationship and an authorization is basically set up between the user and the acquaintances, and a secret is set between the user and each friend so that they can know, in a permitted range, a relationship of them, a communication content between them and a sharing situation of data, and the data that the user uploaded in a push way based on the set friend relationship are shared 1 to 1 between the connected friends, and the information are jointly built between the acquaintances based on the set authorization and the shared data, and the information are re-shared, by means of which a full range of social network service can be achieved, and the present invention can overcome the limits in terms of the data sharing in the mobile communication terminal, so it is possible to overcome the limit in terms of a data sharing using a mobile communication terminal.

### BRIEF DESCRIPTION OF DRAWINGS

FIG. 1 is a view illustrating a concept of a social network service apparatus according to an embodiment of the present invention.

FIG. 2 is a schematic view illustrating a construction of a social network service apparatus of FIG. 1.

FIG. 3 is a view for explaining an example of a cyber space provided in a social network service according to an embodiment of the present invention.

FIG. 4 is a view for explaining an example for storing information with respect to a friend based on a cyber space of FIG. 3.

FIG. 5 is a view for explaining an open key which corresponds to a method for forming multiple friend information at one time of FIG. 4.

FIG. 6 is a view for explaining an example for sharing a message in real time with a friend designated based on a cyber space of FIG. 3.

FIG. 7 is a view for explaining an example for sharing a document with a friend designated based on a cyber space of FIG. 3.

FIG. 8 is a view for explaining an example for managing a schedule with a friend designated based on a cyber space of FIG. 3.

FIG. 9 is a view for explaining an example for sharing an address with a friend designated based on a cyber space of FIG. 3.

FIG. 10 is a view for explaining an example for sharing a material with a friend designated based on a cyber space of FIG. 3.

FIG. 11 is a view for explaining an example for relaying information between friends with the aid of a social network service according to an embodiment of the present invention.

FIG. 12 is a flow chart of a social network service method according to an embodiment of the present invention.

### BEST MODES FOR CARRYING OUT THE INVENTION

The embodiments of the present invention will be described with reference to the accompanying drawings. In the following descriptions, the detailed descriptions on the technology known to those who skilled in the art will be omitted.

During the descriptions of the constructional elements of the present invention, the constructional elements with the same names will be given with different reference numerals depending on the drawings, and the same reference numerals may be given even in different drawings. Even in this case, it does not mean that a corresponding constructional element has a different function depending on the embodiment or it has the same function in different embodiments. The function of each constructional element should be understood based on the descriptions on each constructional element in a corresponding embodiment.

In addition, during the descriptions of the present invention, when it is assumed that the detailed descriptions on the known construction or function may make the gist of the present invention ambiguous, the detailed descriptions may be omitted.

In addition, during the descriptions of the present invention, terms such as the first, the second, A, B, (a), (b), etc. may be employed. These terms are used for the purpose of distinguishing from other elements, not limiting the nature, order or sequence of corresponding constructional elements by such terms. When it is recited like a certain constructional element is “connected”, “engaged” or “coupled” to other constructional elements, the corresponding constructional element may be directly connected or coupled to the other constructional element; however it should be understood like another constructional element may be “connected”, “engaged” or “coupled” between constructional elements.

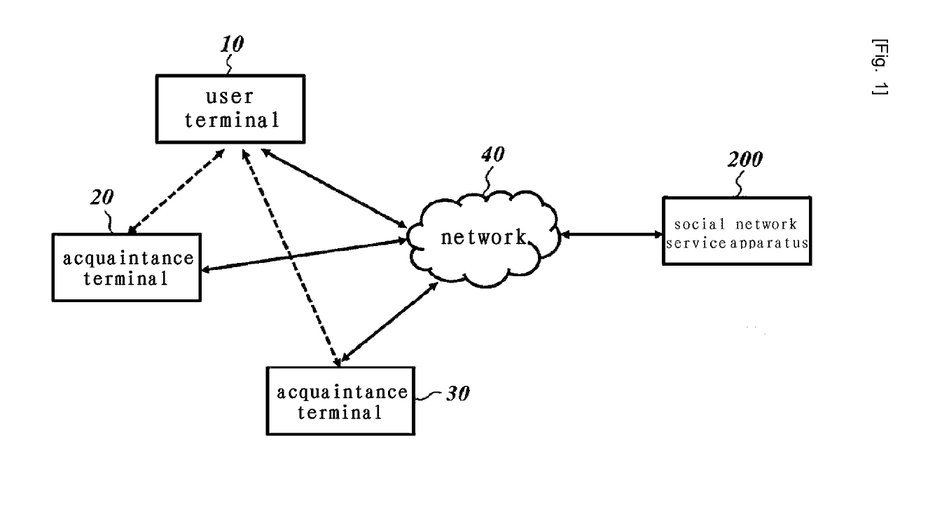

FIG. 1 is a view illustrating a concept of a social network service system according to an embodiment of the present invention. Referring to the drawing, a user terminal 10 of a user and acquaintance terminals 20 and 30 of acquaintances of the user may be connected to a social network service apparatus 200 though a network 40.

Here, the user terminal 10 is a subscriber of a social network service according to an embodiment of the present invention and is a terminal which is connected to the social network service apparatus 200 through the network 40 for thereby uploading data on a cyber space provided by the social network service apparatus 200 for the sake of sharing the data.

The acquaintance terminals 20 and 30 are the terminals of the acquaintances of the social network formed on the internet through the social network service according to an embodiment of the present invention, which acquaintance terminals can be connected to the social network service apparatus 200 through the network 40 and can display the data authorized to the user himself among the data uploaded on the cyber space provided to the user or can output by downloading the same. Here, the terminal for the upload of the data with respect to the cyber space and the terminal of the sharer with respect to the same are sorted into a user terminal 10 and acquaintance terminals 20 and 30.

The user terminal 10 and the acquaintance terminals 20 and 30 include a personal computer (PC), a notebook computer, a personal digital assistant (PDA), a portable multimedia layer (PMP), a play station portable (PSP), a mobile communication terminal, a smart phone, etc.

In addition, the network 40 includes an internet network as well as a mobile communication network and a wireless communication network such as a code division multiple access (CDMA), a wideband code division multiple access (WCDMA), a global system for mobile (GSM), a long term evolution (LTE), and an evolved packet core (EPC).

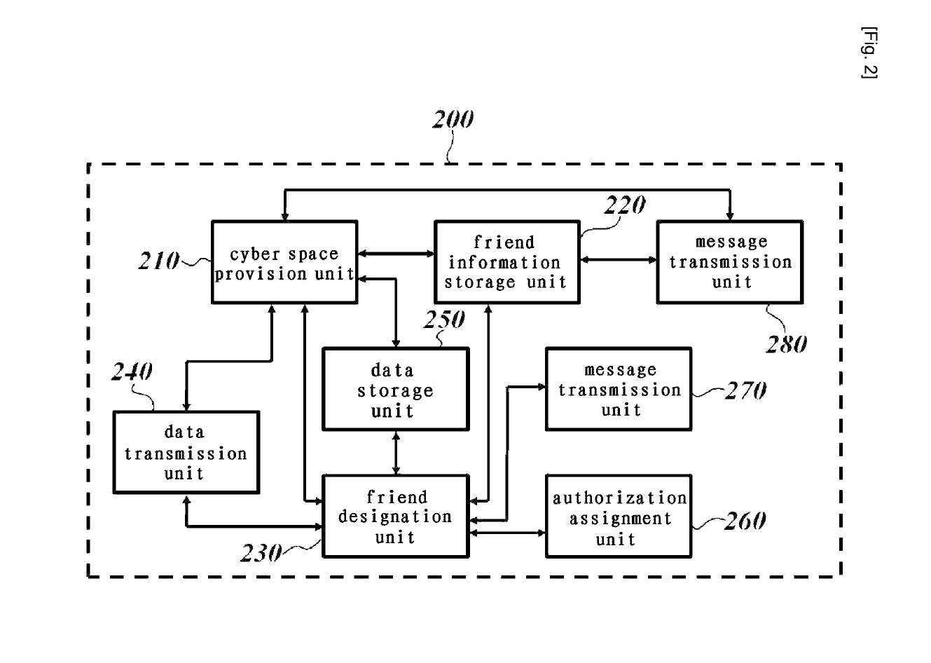

In addition, the social network service apparatus 200 supports a social network service to the user terminal 10 and the acquaintance terminals 20 and 30 through the network 40 for thereby expanding a 1:1 relationship between the user and each acquaintance, so it is possible to form a truly meaningful sharing relationship with the user. The construction and function of the social network service apparatus 200 will be described with reference FIG. 2.

FIG. 2 is a schematic view illustrating a construction of a social network service apparatus according to an embodiment of the present invention. Referring to FIG. 2, the social network service apparatus 200 according to an embodiment of the present invention comprises a cyber space provision unit 210, a friend information storage unit 220, a friend designation unit 230, a data sharing information transmission unit 240 a data storage unit 250, an authorization assignment unit 260 and a message transmission unit 270. Here, the social network service apparatus 200, as described above, may be used as a server supporting a formation of a social network between the user terminal 10 and the acquaintance terminals 20 and 30. At this time, the social network service apparatus 100 of FIG. 2 is shown like it is formed of one server; however each server may be formed of a server performing an independent function. With the interoperations of the servers, it can support a formation of a social network between the user terminal 10 and the acquaintance terminals 20 and 30 according to an embodiment of the present invention.

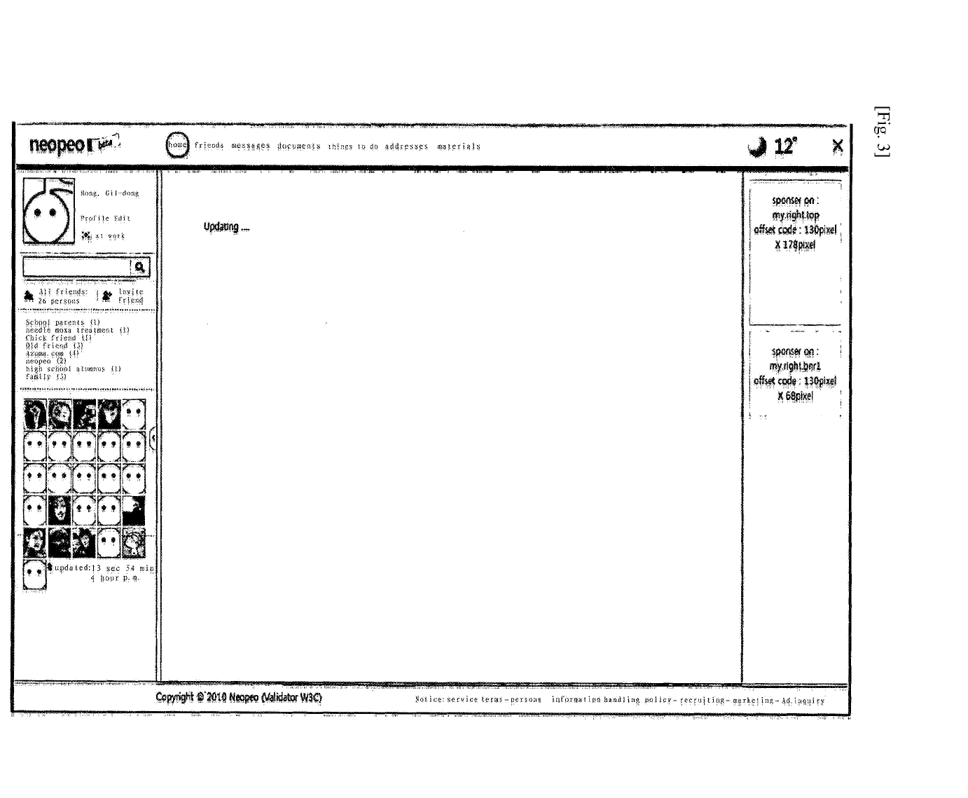

The cyber space provision unit 210 provides a cyber space in which a secret can be exclusively maintained on a network including at least one of a Web page and a Wap page by subscriber. In other words, the cyber space provision unit 210 stores the source of a Web page and provides a cyber space which is designated to a corresponding user terminal 10 and in which a secret can be exclusively kept when the user terminal 10 is connected through a Web browser or a dedicated program. For example, the cyber space provision unit 210 can provide a subscriber, called Hong, Gil-dong, with a Web page type cyber space as shown in FIG. 3. Through the cyber space, the subscriber (Hong, Gil-dong) can upload his own document or a file or can link to the address where stores a specific information on the network. At this time, the data which can be uploaded into the cyber space may be various contents such as a motion picture, an image, a voice file, a document, etc.

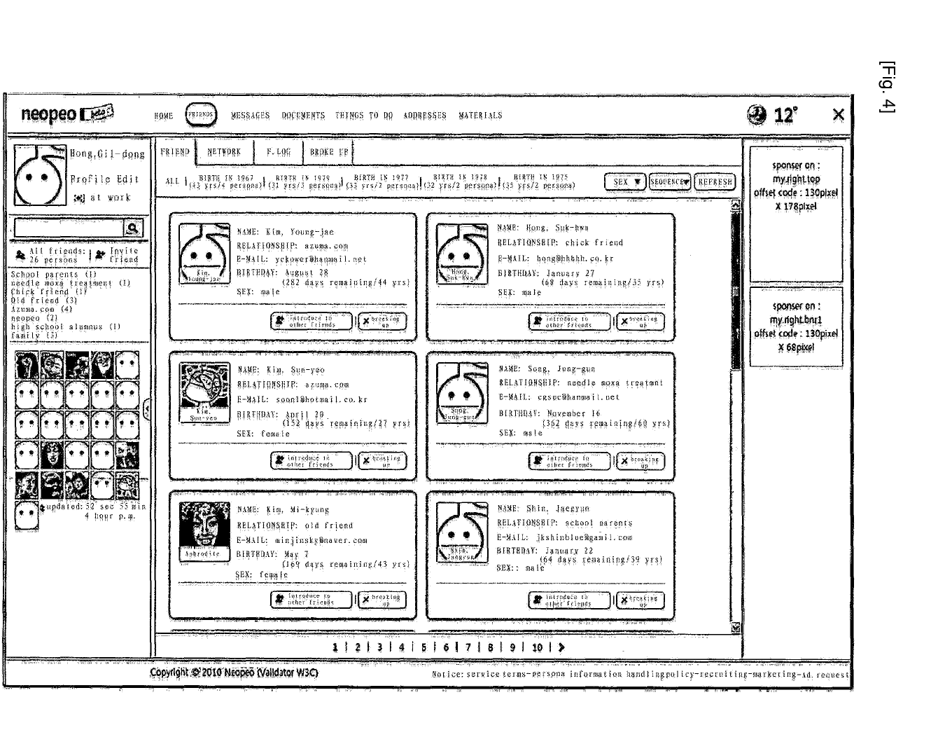

In addition, the subscriber (Hong, Gil-dong) can register the acquaintances formed on the network 40 as the friends in the cyber space as shown in FIG. 4. At this time, the friend information storage unit 220 can sort by the subscriber the information on the friends that each subscriber has registered in the cyber space and can store them as the database. For example, the friend information storage unit 220 can store by sorting the names, e-mail addresses, birthdays and sexes of the registered friends, and an identifier can be inserted in the sorted information for the purpose of identifying a corresponding information. The friend information sorted and stored by the friend information storage unit 220 is not limited to the disclosed contents, and various information can be sorted and stored. In addition, the friend information storage unit 220 has a friend management function of helping register a friend through a search among the subscribers registered to the social network service or registering a friend through an invitation when the acquaintance in real life is subscribed in the social network service or introducing each other the information on the previously registered friends or adding or deleting the friends.

The friend designation unit 230 is configured to designate at least one friend among the friends stored in the friend information storage unit 220 based on the data uploaded and shared in the cyber space by each subscriber. For example, as shown in FIG. 4, the friend that the subscriber (Hong, Gil-dog) has registered in the cyber space is a friend A, a friend B and a friend C and uploads a motion image data and a document data in his own cyber space, the friend A can be designated to the motion image data, and the friend B and the friend C can be designated to the document data.

The data sharing information transmission unit 240 judges the connection state of the user and the connection state of the friend designated by the friend designation unit 230. At this time, the data sharing information transmission unit 240 transmits in a push method the cyber space of the user to the user terminal 10 when it is judged that the user has connected and shares the same, so it becomes possible to amend or delete the data uploaded and shared by the user and to further upload and share the other data. In addition, the data sharing information transmission unit 240 transmits, in a push method at a certain cycle, the shared information of the data to which the sharing authorization is assigned as it is uploaded in the user's cyber space in the acquaintance terminals 20 and 30 of a corresponding friend when it is judged that the friend designated by the friend designated unit 230 has connected. For example, in case of the above mentioned subscriber (Hong, Gil-dong), the data sharing information transmission unit 240 transmits in a push method at a certain cycle the motion image data sharing information to the terminal of the friend A when it is judged that the friend A has connected for thereby allowing a connection to the sharing authorization-assigned motion image data. When it is judged that the friend B or the friend C has connected, the document is transmitted in a push method at a certain cycle to the terminal of the friend B or the friend C for thereby allowing a connection to the sharing authorization-assigned document data.

Here, the data sharing information transmission unit 240 is named because the data uploaded by the user is copied but is not transmitted to the terminal of the designated friend, and instead only the information such as the sharing authorization and read, amendment, deletion, addition and transfer, etc. of the uploaded data is transferred. In other words, in terms of the uploaded data it operates in such a way that only one data uploaded by the user is present in the data storage unit 230. The friends with a sharing authorization with respect to one uploaded data can connect to the data registered in the data storage unit 230 with the sharing authorization, and the data can be shared.

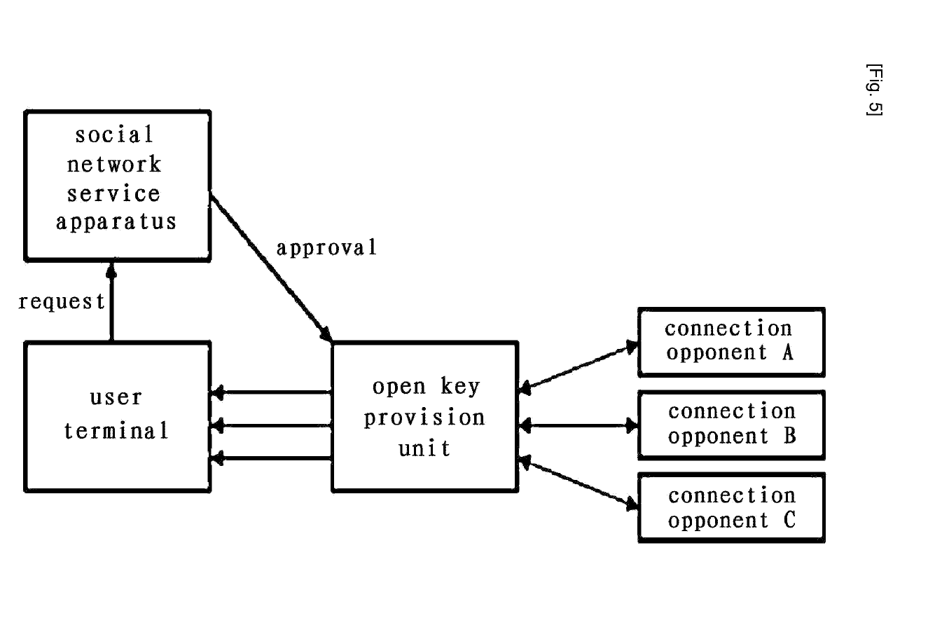

FIG. 5 is a view for explaining an open key which is a method for forming multiple friend information at one time shown in FIG. 4. Generally speaking, in terms of the friend relationship of FIG. 3, the friends can be registered through the search among the subscribers subscribed in the social network service of the present invention or in case that the acquaintance of a real life is subscribed in the social network service, the friend can be registered through an invitation or can be separately registered through a procedure such as an introduction, an addition and a deletion of the information with respect to the previously registered friends; however as compared thereto, it can be applied when it needs to make at a time multiple friend relationships, for example, for the sake of a club, alumnus or business. In terms of the open key provision unit 280, when a user needs to form multiple friend relationships at a time, the open key is assigned from the open key provision unit 280, and it is provided in a cyber space which becomes a contact point with people who want to form a friend relationship such as a blog, a cafe, a shopping mall, a homepage, a social network service page, etc., and they click the open key, and the cyber space provision unit 210 provides a cyber space to them immediately, through which they can make friend relationships with the user. The friend ground with the friend relationship made with the open key is stored in the friend information storage unit 220 or may be sorted from the previously separately formed friends and may be separately stored. However, the other function portions such as other data sharing, etc. can be identically adapted.

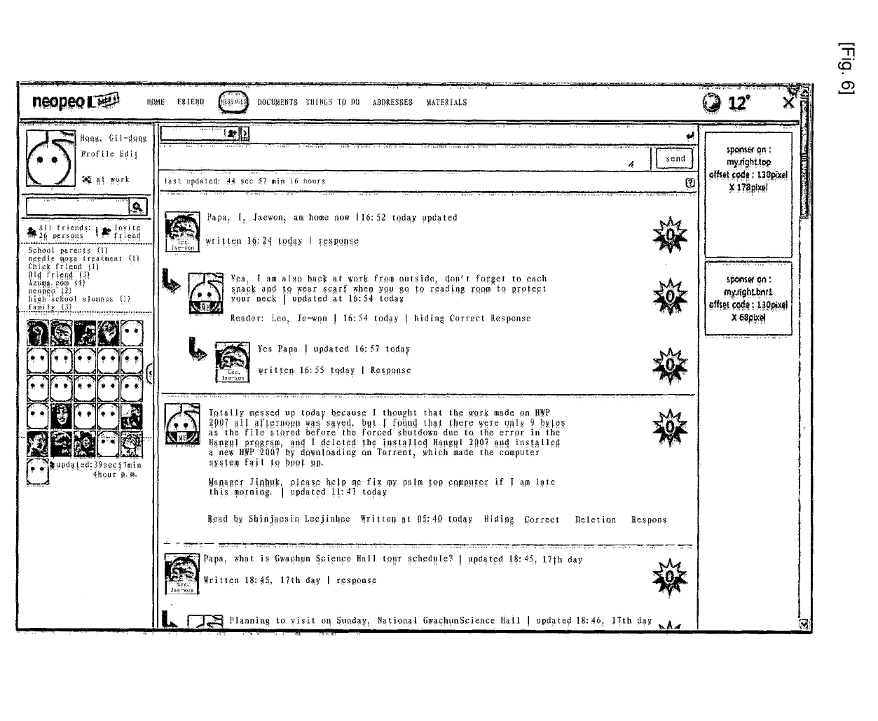

FIG. 6 is a view for explaining an example for sharing a message in real time with a friend designated based on a cyber space of FIG. 3. As shown therein, the subscriber designates the friends displayed as being currently connected among his friends and communicates in real time on the messages with corresponding friends, and can communicates on the messages with the friends who are not connected. In this case, when a corresponding friend is connected with the social network service apparatus 200, it is received on the friend's terminal and is displayed thereon. The real time message explained in the drawings of the present invention is not limited to only the transfer of the simple text characters, but it can be used for the attachments of files such as an image, a motion image, a file, etc. and for a transfer of map information at a time, so as compared to the typical method, various and abundant communications can be made.

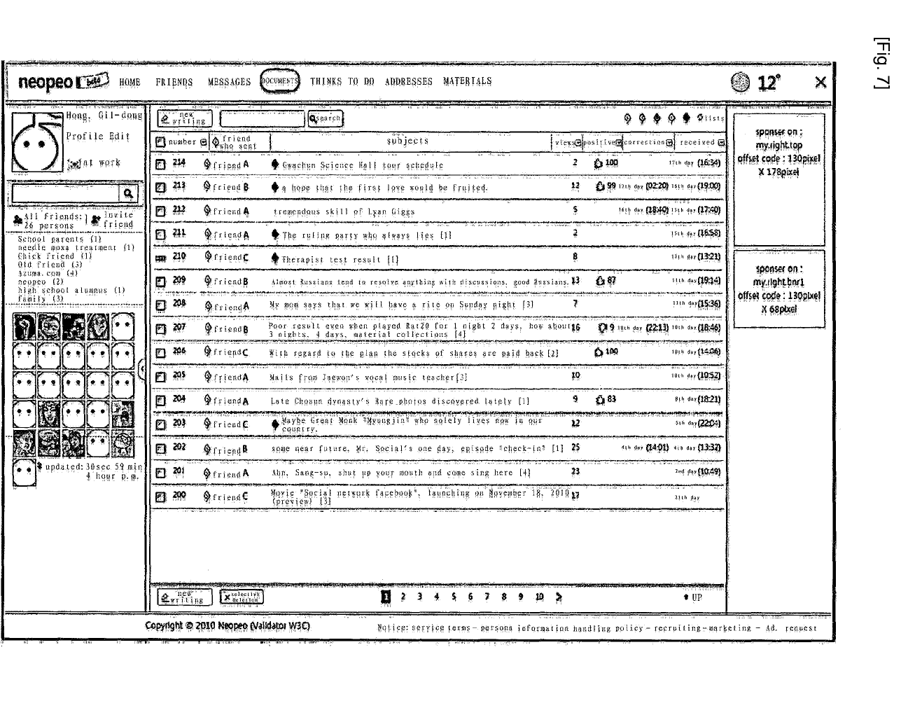

FIG. 7 is a view for explaining an example for sharing a document with a friend designated based on the cyber space of FIG. 3. It shows an example in which a data that the acquaintances (friend A, friend B and friend C) that the subscriber (Hong, Gil-dong) has designated as friends upload, with the authorization of the date being assigned to the subscriber (Hong, Gil-dong). In other words, when the acquaintances who have designated the subscriber (Hong, Gil-dong) as their friends upload the data in their cyber spaces and designate the subscriber (Hong, Gil-dong) as a friend having a sharing authorization with respect to the data, and when the subscriber (Hong, Gil-dong) connects to the social network service apparatus 200, the data assigned with the sharing authorization can be received on the terminal of the subscriber and can be displayed thereon. At this time, while the subscriber is being connected to the social network service apparatus 200, the data information assigned with the sharing authorization among the data uploaded on the cyber space of each acquaintance can be continuously received at a constant cycle on the subscriber. As shown in FIG. 7, the thusly-received data sharing information can be displayed on the subscriber terminal in the form of a list, and when one of the displayed lists is selected, it can be implemented in such a way that the uploaded data corresponding to the selection can be displayed.

The data storage unit 250 stores the data uploaded in the cyber space provided by the subscriber in relation with the friends assigned with the sharing authorization by means of the subscriber and friend designation unit 230. In case of the earlier described subscriber (Hong, Gil-dong), the uploaded motion image data is stored in relation with the designated friend A, and the document data is stored in relation with the friend B and the friend C assigned with the sharing authorization. At this time, the data storage unit 250 sorts the data uploaded in the cyber space provided by the subscriber to have a link information showing the contents having a motion image and an image, documents, schedule and storage position of other information and stores them.

The authorization assignment unit 260 can assign an authorization with respect to at least one among a read, addition, modification, deletion, transfer, etc. with respect to each friend designated by the friend designation unit 230. For example, in case of the earlier described subscriber (Hong, Gil-dong), the authorization assignment unit 260 assigns only the read authorization to the friend A designated to the uploaded and shared motion image data, and assigns the read, addition and modification authorizations to the friend B who is designated with respect to the uploaded and shared document data, and assigns the read, addition, modification, deletion and transfer authorities to the friend C. In this case, the friend A can only read, namely, view the motion image data of the subscriber (Hong, Gil-dong) displayed on his own terminal when he is connected to the social network service apparatus 200. The friend B can read, add and modify the document data of the subscriber (Hong, Gil-dong) displayed on his own terminal. The friend C can read, add and modify or can delete the document data uploaded by the subscriber (Hong, Gil-dong) or provide the sharing authorizations to other acquaintances of him and transfer them.

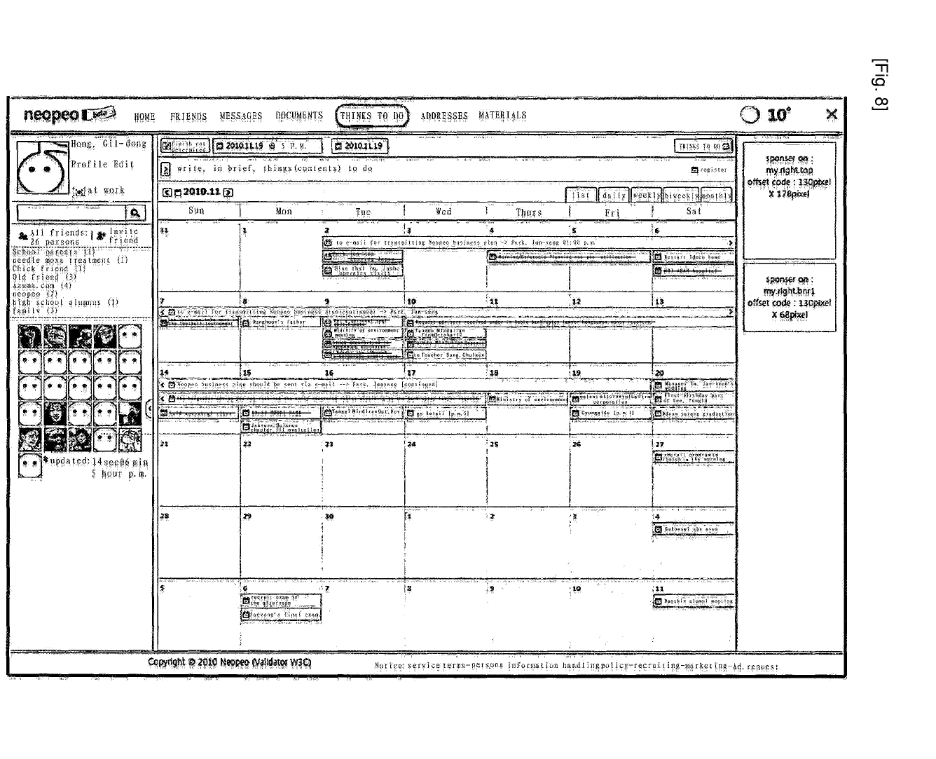

FIG. 8 is a view for explaining an example for managing a schedule with a friend designated based on the cyber space of FIG. 3. As shown therein, the subscriber uploads a data on a schedule management in his own cyber space, and designates a friend with respect to the uploaded schedule management data, and assigns an authorization such as an addition, deletion and modification, so the subscriber and the designated friend can share the schedule between them, and in particular the schedule of the drawings of the present invention contains the sharing of the time related information and text information, and further contains the attachments of the image, motion image, file, etc. for each schedule as well as the registration of the map information at a time, so as compared to a typical method, various and abundant communication are possible. In addition, the sharing can be individually possible for each schedule, so various individual relationships such as a friendship activity and business between acquaintances can be usefully applied.

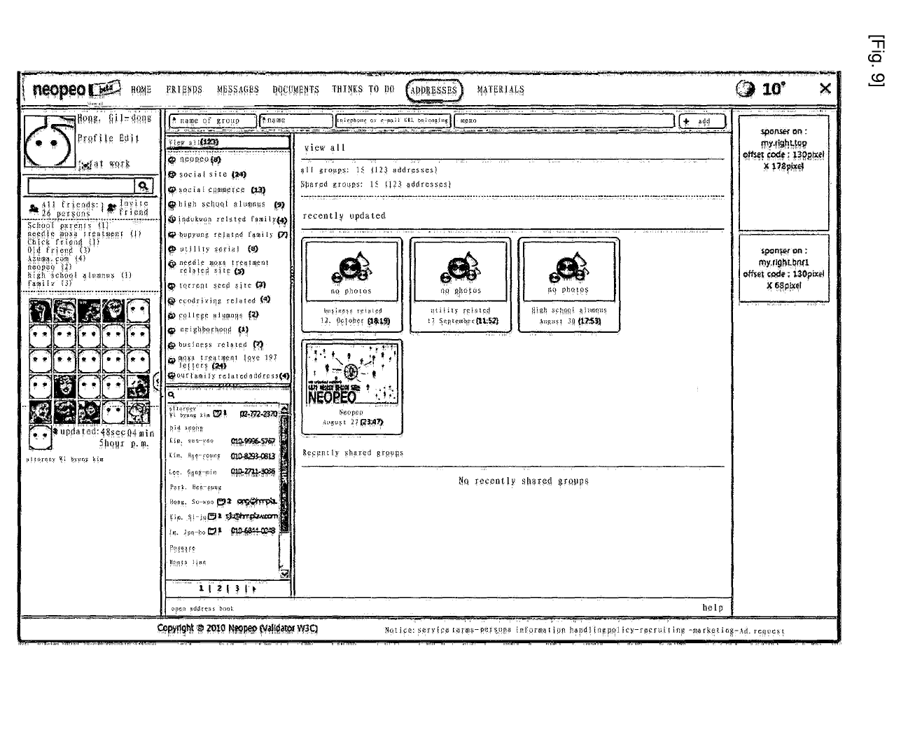

FIG. 9 is a view illustrating for explaining an example for sharing a friend and an address designated based on a cyber space of FIG. 3 and an address. As shown therein, the subscriber makes a common address information and an address group with respect to an information of a specific subject and registers the position information with respect to the information of the specific subject, and registers the position information of the internet in which the address group stores the related addresses and the related information and uploads them in the cyber space and designates the friends who will share the address group and provides the designated friends with the addition, modification, deletion and transfer authorizations with respect to the address group, the registered addresses and the position information of the internet. In this case, if the designated friend knows the addresses with more specific and expanded information as compared to the address information uploaded in the cyber space, a corresponding information can be added or deleted or can be transferred to other friends who need them, and the user as well as related friends can share more expanded information with respect to specific subjects.

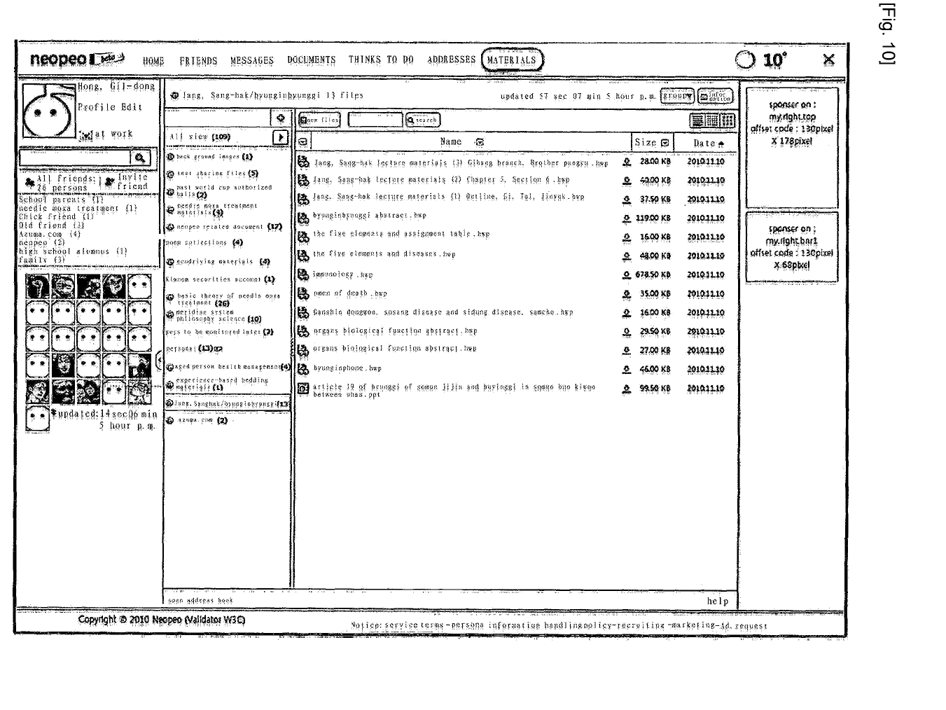

FIG. 10 is a view for explaining an example for sharing the friends and materials designated based on the cyber space of FIG. 3. As shown therein, the subscriber can make a material group on a specific subject and can register the material related with the material group and can directly upload them in his own cyber space and can designate the friends who can share the uploaded material group and can assign the designated friends with modification, deletion, addition and transfer authorizations. In this case, the designated friend can modify and delete when the material information uploaded in the cyber space is wrong and can transfer a corresponding material to other acquaintances who know in details for thereby correcting or adding the wrong materials. With the modification, deletion, addition and transfer authorization of the above mentioned materials, it is possible to build high reliability information, and the related friends can share the more expanded material information.

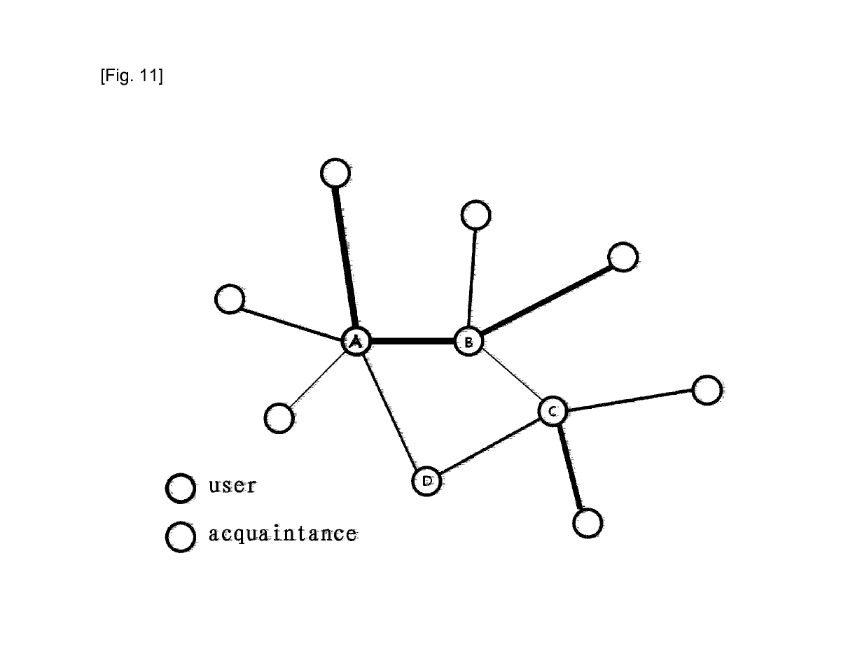

FIG. 11 is a view for explaining an example for relaying the information with the aid of the social network service according to an embodiment of the present invention. The above information relay can be formed by the transfer authorization of the data. For example, the user A can designate the friend B with respect to the data uploaded in his own cyber space and assign the sharing authorization as well as assign a transfer authorization, and the friend B can designate the friend C with respect to the data shared by the user A and assign the sharing authorization as well as the transfer authorization. In this manner, the data uploaded in the cyber space by the user A can be continuously transferred to the others by the sharing and transfer authorizations, and can be modified or added. So, the adaptive information can be built depending on the era and circumference, thus enhancing the reliability of the information. The subscribers at each stage can share the information, so they can share higher quality information than the quality of the information that he can obtain for himself. In the drawings, it is shown like the final receiver D is the acquaintance of the user A during the continued transfer procedure; however the receiver D may not be the acquaintance of the user A, and the transfer procedure can be continuously performed.

When the user uploads the data in the cyber space of the user, and it is judged that the acquaintance designated as a friend of a corresponding data is not connected, the message transmission unit 270 can transfer a guide message, which guides a connection, to the terminal of a corresponding designated friend. For example, when the earlier mentioned subscriber (Hong, Gil-dong) uploads the document data in a cyber space, and it is judged that the friend B designated as a friend who is assigned with the sharing authorization of a corresponding document data is not connected, the message transmission unit 270 cooperates with the short message server (SMS) (not shown) and transmits to the terminal of the friend B a message guiding a connection to the social network service apparatus 200.

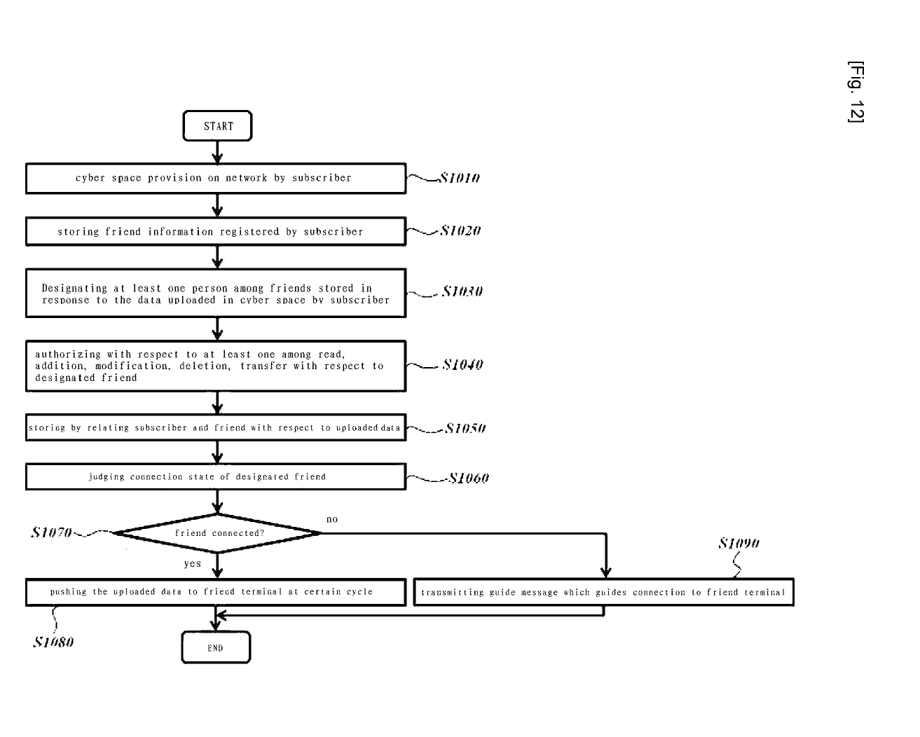

FIG. 12 is a flow chart of a social network service method according to an embodiment of the present invention, while showing a social network service method based on the social network service apparatus 200 of FIG. 2.

Referring to FIGS. 2 and 12, the cyber space provision unit 210 provides a cyber space in which a secret is exclusively kept on the network containing at least one of a Web page and a Wap page by the subscriber (S1010). In other words, the cyber space provision unit 210 can provide a cyber space which is designated in a corresponding user terminal 10 and can store the source of the Web page and in which a secret can be exclusively kept when the user terminal 10 connects through a Web browser or a dedicated program.

The friend information storage unit 220 sorts by the subscriber the information on the friends registered in the cyber space by the subscriber and stores in the database (S1020). For example, as shown in FIG. 3, the friend information storage unit 220 can store the friend A, the friend B and the friend C as the fiends with respect to the subscriber (Hong, Gil-dong).

The friend designation unit 230 can designate one of the friends stored in the friend information storage unit 220 as a friend having a sharing authorization in response to the data uploaded in the cyber space by each subscriber (S1030). For example, as shown in FIG. 4, when the friend registered in the cyber space by the subscriber (Hong, Gil-dong) uploads the motion image data and the document data in his own cyber space, the friend A is designated as a friend having a sharing authorization with respect to the motion image data, and the friend B and the friend C are designated as friends having a sharing authorization with respect to the document data.

The authorization assignment unit 260 can assign an authorization with respect to at least one among a read, addition, modification, deletion and transfer with respect to each friend designated by the friend designation unit 230 (S1040). For example, in case of the earlier mentioned subscriber (Hong, Gil-dong), the authorization assignment unit 260 assigns only the read authorization to the friend A designated with respect to the uploaded motion image data, and assigns the read, addition and modification authorization to the friend B designated with respect to the uploaded document data, and assigns the read, addition, modification, deletion and transfer authorizations to the friend C. In this case, the friend A can read, namely, view only the motion image data uploaded by the subscriber (Hong, Gil-dong) displayed on his own terminal when he is connected to the social network service apparatus 200, the motion image data providing a sharing authorization to the friend A, and the friend B can read, add and modify only the document data uploaded by the subscriber (Hong, Gil-dong) displayed on his own terminal and designating the friend B as having a sharing authorization, and the friend C can read, add and modify as well as delete the document data uploaded by the subscriber (Hong, Gil-dong) and designating the friend C as a friend having a sharing authorization and can transfer the same to his other acquaintances.

The data storage unit 250 stores the data uploaded in the cyber space provided by the subscriber along with the authorization assigned to each designated friend in relation with the friends designated as a friend having a sharing authorization by the subscriber and the friend designation unit 230 and the authorization information with respect to a read, modification, deletion, addition and transfer (S1050). In case of the earlier mentioned subscriber (Hong, Gil-dong), it stores what the read authorization is assigned in relation with the friend A designated as a friend having a sharing authorization with respect to the uploaded motion image data, and it also stores along with the authorization assigned to each in relation with the friend B and the friend C designated as a friend having a sharing authorization with respect to the document data. At this time, the data storage unit 250 sorts the data uploaded in the cyber space provided by the subscriber as a link information representing the storage positions of the contents, document, schedule management and other information containing the motion images, the image, etc.

The data sharing information transmission unit 240 judges the connection state of the user and the connection state of the friend designated by the friend designation unit 230 (S1060), and when the designated friend is connected (S1070), the sharing authorization of the data uploaded by the user and the authorization information such as a read, modification, deletion, addition, transfer, etc. are pushed to the designated friend terminal at a certain period and are transmitted (S 1080). Here, the data uploaded by the user is copied and not transmitted to the terminal of the designated friend, but only the sharing authorization of the uploaded data and the information such as the read, modification, deletion, addition, transfer, etc, are transferred. In other words, in terms of the uploaded data, only one data uploaded by the user is present in the data storage unit 230. The friends having a sharing authorization with respect to the uploaded data connect to the data registered in the data storage unit 230 through the sharing authorization, and it operates in the shared type.

If it is judged that the designated friend is not connected (S1070), the message transmission part 270 can transmit a guide message to the terminal of a corresponding friend for the purpose of guiding the connection to the social network service apparatus 200 (S1090).

All the constructional elements of the embodiments of the present invention have been described operating as they are engaged as one element; however the present invention is not limited to such embodiments. In other words, within the ranges of the objects of the present invention, at least two elements among the above mentioned constructional elements may be selectively engaged and operate. In addition, all constructional elements may be implemented in a form of an independent hardware as one element; however part or all of the above constructional elements may be selectively combined for thereby being implemented as one a computer program having a program module performing part or all of the functions combined from one or multiple hardware. In addition, the computer program is stored in the computer readable media such as a USB memory, a CD disk, a flash memory, etc., so it is read by the computer and is executed for thereby implementing the embodiment of the present invention. The storage medium of the computer program comprise a magnetic recording medium, an optical recording medium, a carrier wave medium, etc.

All the terms including technical or science terms have the same meaning as those who skilled in the art understand unless otherwise stated in the detailed description of the present invention. The terms generally used like the terms defined in the dictionary should be interpreted as matching with the meaning of the context of the related technology, and they should be interpreted in ideal or over formal meaning unless otherwise stated in the present invention.

As the present invention may be embodied in several forms without departing from the spirit or essential characteristics thereof, it should also be understood that the above-described examples are not limited by any of the details of the foregoing description, unless otherwise specified, but rather should be construed broadly within its spirit and scope as defined in the appended claims, and therefore all changes and modifications that fall within the meets and bounds of the claims, or equivalences of such meets and bounds are therefore intended to be embraced by the appended claims.

1. A social network service apparatus, comprising:
a cyber space provision unit providing a cyber space in which a secret is exclusively kept on a network including by the subscriber at least one among a Web page and a Wap page;
a friend information storage unit storing an information on a friend registered by the subscriber;
a friend designation unit which designates as a communication opponent at least one among the friends stored in the friend information storage unit by each subscriber or designates, as a person having a sharing authorization of the data, at least one among the friends stored in the friend information storage unit in response to the data uploaded in the cyber space; and
a data sharing information transmission unit which judges a connection state of a friend designated by the friend designation unit and pushes to the terminal of the designated friend a sharing information of the data among the data uploaded in the cyber space, the sharing authorization of the data being assigned to a corresponding friend.

2. A social network service apparatus of claim 1, further comprising:
a data storage unit for storing the data by relating the subscriber and a friend designated by the friend designation unit to the sharing authorization of the data uploaded with respect to the data uploaded in the cyber space and the authorization information including at least one selected from among a modification, a deletion, an addition and a transfer.

3. A social network service apparatus of claim 1, further comprising an authorization assignment unit for assigning an authorization with respect to at least one selected from among a read, an addition, a modification, a deletion and a transfer with respect to the friend designated by the friend designation unit.

4. A social network service apparatus of claim 1, further comprising a message transmission unit for transmitting a guide message to the terminal of the designated friend for guiding a connection when it is judged that the designated friend is not connected when the data is uploaded in the cyber space.

5. A social network service apparatus of claim 1, wherein the data sharing information transmission unit judges a connection state of the subscriber corresponding to the data uploaded in the cyber space, and searches a data uploaded in the cyber space on the terminal of the subscriber when the subscriber is connected and pushes at a certain cycle the data, the sharing authorization of which is assigned to the subscriber, to the terminal of the subscriber.

6. A social network service apparatus of claim 2, wherein the data storage unit sorts the data uploaded in the cyber space as one of a content, a document, a schedule management, an address information and a material information and stores them.

7. A social network service method, comprising:
Providing a cyber space in which a secret is exclusively kept on a network including by the subscriber at least one among a Web page and a Wap page;
storing an information on a friend registered by the subscriber;
designating as a communication opponent at least one of the friends stored in the friend information storing step by each subscriber by corresponding to the data uploaded in the cyber space by each subscriber or designating as a friend having a sharing authorization of the data at least one person among the friends stored in the friend information storage step by corresponding to the data uploaded in the cyber space;
judging a connection state of the friend designated by the friend designation unit; and
pushing at a certain cycle the data the sharing authorization of which is assigned to a corresponding friend, among the data uploaded in the cyber space, to the terminal of the designated friend when the designated friend is connected.

8. A social network service method of claim 7, further comprising:
storing the data by relating the subscriber with respect to the data uploaded in the cyber space and a friend designated to the sharing authorization of the data uploaded by the friend designation unit.

9. A social network service method of claim 7, further comprising:
assigning an authorization with respect to at least one among a read, an addition, a modification, a deletion and a transfer with respect to the friend designated by the friend designation step.

10. A social network service method of claim 7, further comprising:
transmitting a guide message, which guides a connection, to the terminal to the terminal of the designated friend when it is judged that the designated friend is not connected when the data is uploaded in the cyber space.

11. A social network service method of claim 7, wherein the data push step judges a connection state of the subscriber corresponding to the data uploaded in the cyber space, and searches a data uploaded in the cyber space on the terminal of the subscriber when the subscriber is connected and pushes at a certain cycle the data, the sharing authorization of which is assigned to the subscriber, to the terminal of the subscriber.

12. A social network service method of claim 6, wherein the data storage step sorts the data uploaded in the cyber space as one of a content, a document, a schedule management, an address information and a material information and stores them.

13. A social network service method of claim 7, wherein the friend who is assigned (provided) with a sharing authorization with respect to the data uploaded in the cyber space and the authorization information including at least one among a modification, a deletion, an addition and a transfer relays a corresponding data to other friends who have a friend relationship with himself.

14. A social network service method of claim 7, wherein two persons having friend relationship with himself in terms of the friend relationship are in an exclusive secret relationship with respect to a personal information so that the two persons cannot now ant information on themselves before they make a friend relationship with each other.

15. A social network service method of claim 7, wherein the data is copied between a transmitter and a receiver with respect to the data uploaded in the cyber space and is not transmitted, and only one data is generated, and a sharing authorization with respect to the data is assigned to the friends who becomes a receiving opponent of the data, and a sharing information is transmitted from the data sharing information transmission unit to the friends who are assigned with a sharing authorization, and the friends having the sharing authorizations can connect to a corresponding data.

16. A social network service method of claim 7, wherein a cyber space provision unit immediately provides a cyber space to the persons who click an open key by receiving an open key and disposing the same in the cyber space which becomes a contact point with the persons who want a friend relationship for thereby making a friend relationship with the user, and the friend information storage unit separately sorts the friends and stores and manage them.

17. A social network service method of claim 7, wherein in case that a user shares a communication and data with the friends, even when a communication and data are shared by designating multiple friends, each friend is connected with a user based on a 1:1 connection, and it is displayed as a 1:1 relationship so that the friends can feel such connection like a private relationship communication.

18. A social network service method of claim 7, wherein there is provided a combined multimedia method which can provide an image, a motion image and a file as well as a map information in addition to a real time message and the information provided by the cyber space provision unit and transferred in a simple form of text in a shared schedule which are serviced in a cyber space in which a secret is exclusively kept on the network.
